(19) United States
(12) Patent Application Publication
(10) Pub. No.: US 2008/0156431 A1
(43) Pub. Date: Jul. 3, 2008

(54) CUSTOMIZABLE NOTEBOOK PANELS

(76) Inventors: George H. Daskalakis, Forest Grove, OR (US); Hong W. Wong, Portland, OR (US); Daryl J. Nelson, Beaverton, OR (US); Ed H. Kohlman, Tigard, OR (US); Michael S. Harrison, Folsom, CA (US); Emity Pan, Shanghai (CN); Wah Yiu Kwong, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/617,575

(22) Filed: Dec. 28, 2006

(51) Int. Cl. B32B 37/12

(52) U.S. Cl. 156/277

(57) ABSTRACT

A customizable notebook panel (CNP) manufactured with a photo image is to be attached to a surface of a computer system using a white color adhesive. To prevent streaks and bubbles from being visible on the CNP, a filler layer is used in between the CNP and the surface. Other techniques to reduce the visibility of the streaks and bubbles may include increasing the thickness of the adhesive layer and using inks that are opaque.

### FIELD OF THE INVENTION

The present invention relates generally to field of computer system design. More specifically, the present invention relates to techniques of designing computer system panels.

### BACKGROUND

Typically, portable computer systems available in the market today come in standard solid skin color such as, for example, black. Most of the manufacturers of the portable computer systems do not provide any option to personalize the skin. For some manufacturers that do provide the option, the option may include applying an image panel on the skin using some types of adhesive. This has not been a good technique because bubbles begin to appear on the image panel when certain conditions exist causing the image panel to lose its original clarity.

### BRIEF DESCRIPTION OF THE DRAWINGS

The present invention is illustrated by way of example, and not limitation, in the figures of the accompanying drawings in which like references indicate similar elements and in which:

FIG. 1 illustrates an example of a notebook computer system, in accordance with some embodiments.

FIG. 2 illustrates an example of a notebook computer system with a CNP attached to the A-cover, in accordance with some embodiments.

FIG. 3 illustrates one example of a technique that may be used to attach a CNP to an A-cover of a notebook computer system, in accordance with some embodiments.

FIGS. 4A-4B illustrate some examples where CNP may be used, in accordance with some embodiments.

FIG. 5 is a block diagram that illustrates an example of a process that may be used to prevent problems that may be associated with using CNP in notebook computer systems, in accordance with some embodiments.

### DETAILED DESCRIPTION

For some embodiment, techniques to design and apply customizable notebook panels (CNP) for portable or notebook computer systems are disclosed. The techniques may include using a type of adhesive or a type of ink color to reduce streaks and bubble effect that may appear on the CNP when the CNP is exposed to various environmental condition.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

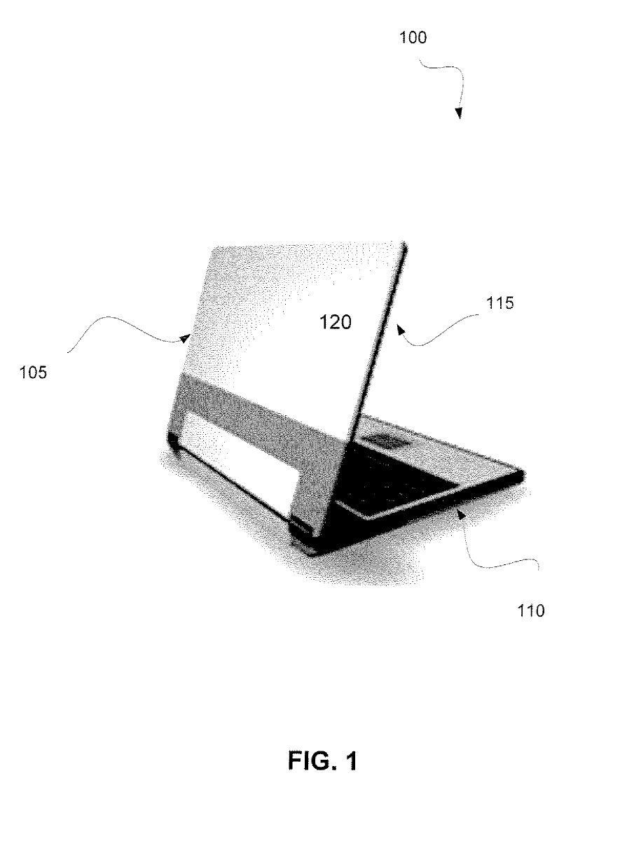

Generally in a notebook computer system that has the normal clam-shell form factor, the skin side associated with the display screen is most visible. FIG. 1 illustrates an example of a notebook computer system, in accordance with some embodiments. Computer system 100 includes a lid unit 105 and a base unit 110. The lid unit 105 may include a display screen on an interior side 115 and a skin cover on exterior side 120. In the following description, the skin cover on the exterior side 120 may be referred to herein as an A-cover. The computer system 100 may be referred to as a bare bone notebook computer system because it does not have a CNP on the A-cover.

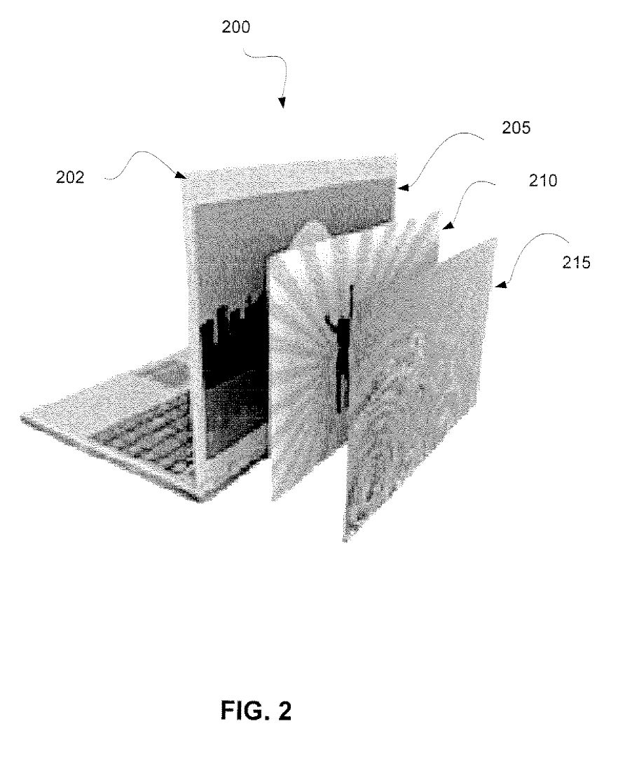

FIG. 2 illustrates an example of a notebook computer system with a CNP attached to the A-cover, in accordance with some embodiments. Computer system 200 is illustrated to include CNP 205 attached to A-cover 202. Adding the CNP 205 on the A-cover 202 may add visual interest to the computer system 200 giving it a different and unique appearance. A company may use the A-cover 202 to promote brand by including its company logo or marketing message on the CNP 205. Users may use the CNP 205 to show individual personality, etc.

For some embodiments, the A-cover 202 may include a recess to accommodate the CNP 205 and to enable the CNP 205 to be attached quickly and easily. Depending on the design of the CNP, the CNP 205 may be attached permanently or non-permanently. A Pressure Sensitive Adhesive (PSA) that is a double-sided sticky adhesive may be used to connect the A-cover 202 of the notebook computer system 200 to the CNP 205. When the CNP 205 is attached permanently, removal of the CNP 205 may cause damage to the A-cover 202. When the CNP 205 is attached non-permanently to the A-cover 202, it may be released easily and cleanly from the A-cover 202. As such, the type of adhesive used may be of interest if the CNP 205 is to be attached non-permanently or temporarily. In the current example, when using a non-permanent adhesive, the CNP 205 may be released and replaced by CNP 210 or CNP 215.

As illustrated in FIG. 2, a CNP may include graphics design or custom photo images. Although a variety of materials may be used, some of the materials that may be used to create the CNP may include polycarbonate or vinyl for durability, cost effectiveness, and consistency. Digital printing of photo images on the vinyl material may be less costly and may provide more photo realistic effect than screen printing on polycarbonate material. The thickness of the CNP may be about less than 0.5 mm. Once customized with a photo image, the piece of polycarbonate or vinyl material may be inserted into the A-cover of the bare bone notebook computer system.

When using custom photo images, the images may be on the CNP material. In these situations, it has been realized that the images may lose their clarity when the CNP is applied to the A-cover. This may be caused by streaks or bubbles that become noticeable after the CNP is applied to the A-cover. The streaks or bubbles may be present when there is one or more portions of the image include solid light colors. The streaks or bubbles may be visible when the CNP with the images are manufactured with digital printing, and the inks used may not be opaque enough to block the light. In addition, when using polycarbonate, the images may be printed on the back side of a clear film which may cause the bubbles to occur after being exposed to the environment. Furthermore, when the adhesive used is a clear adhesive, the imperfections (e.g., streaks) of the adhesive layer when it is applied to the A-cover are visible light color areas of the CNP.

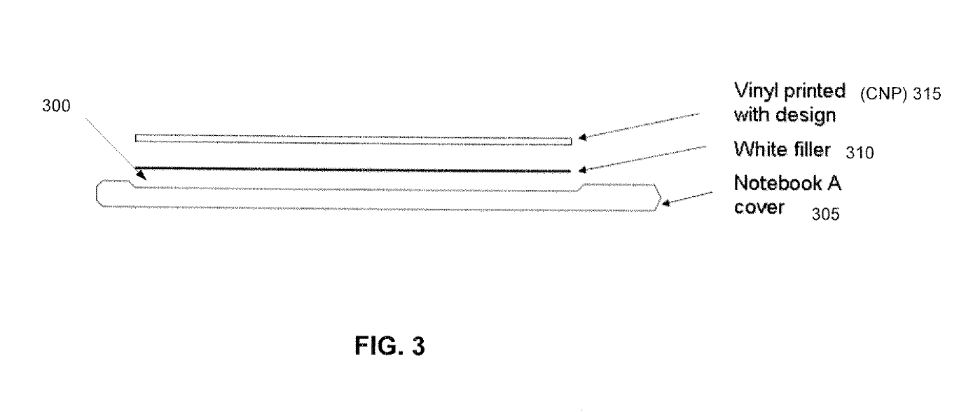

FIG. 3 illustrates one example of a technique that may be used to attach a GNP to an A-cover of a notebook computer system, in accordance with some embodiments. Notebook A-cover 305 includes a recess area 300 to accommodate CNP 315. In this example, the CNP 315 is a vinyl printed with a design such as a photo image. For some embodiments, a filler layer 310 is introduced in between the CNP 315 and the A-cover 305. The filler layer 310 may be used to block out the bubbles formed by the clear adhesive on the A-cover 305. The filler layer 310 may be white or any solid color. For some embodiments, the filler layer 310 may be integrated into the CNP 315 as part of the manufacturing process of the CNP 315.

For some embodiments, to prevent the imperfections of the adhesive from showing through the light color areas of the images, a white color adhesive may be used instead of the clear adhesive. The white color adhesive may be a permanent type or a non-permanent type. For some embodiments, when the CNP is manufactured using silk screening process (such as when using polycarbonate as the CNP material), inks that are more opaque may be used. For some embodiments, a white or light color vinyl film may be applied to the CNP instead of a clear vinyl film (such as when using polycarbonate as the CNP material) and the photo image is printed on the top side of the white or light color vinyl film instead of on the backside of the clear vinyl film.

For some embodiments, to prevent the imperfections caused by the adhesive from showing through the CNP, the surface energy of the A-cover may be increased, or the surface energy of the adhesive may be increased such that it is less than or at most equal to the surface energy of the A-cover. Increasing the thickness of the adhesive may improve the wetting surface area and may reduce the voids or imperfections to the point that the number of visible streaks or bubbles is less noticeable, and therefore not showing through the CNP, especially if there is any texture on the recess area.

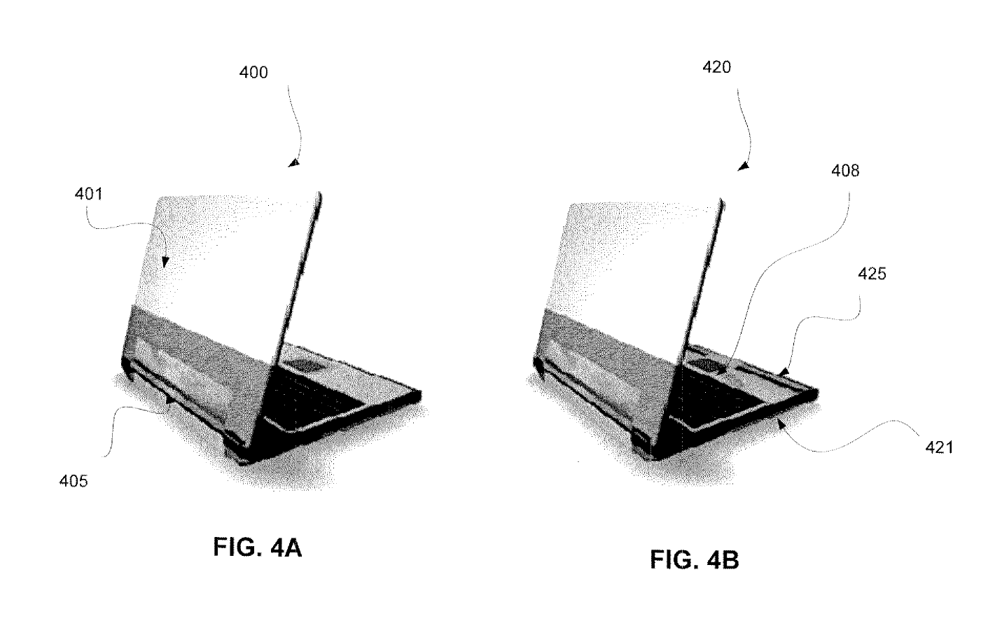

FIGS. 4A-4B illustrate some examples where CNP may be used, in accordance with some embodiments. For some embodiments, in addition to the A-cover illustrated in FIG. 2, CNPs may be applied to other areas of the notebook computer systems to provide further customization. Referring to FIG. 4A, a CNP 405 may be attached to the lid unit 401 of notebook computer system 400. Referring to FIG. 4B, a CNP 425 may be attached to base unit 421 of notebook computer system 420. The CNP 425 may be attached in the area below a keyboard 408 on a similar plane as a touchpad. The techniques described above may be used to attach the CNP 405 and the CNP 425.

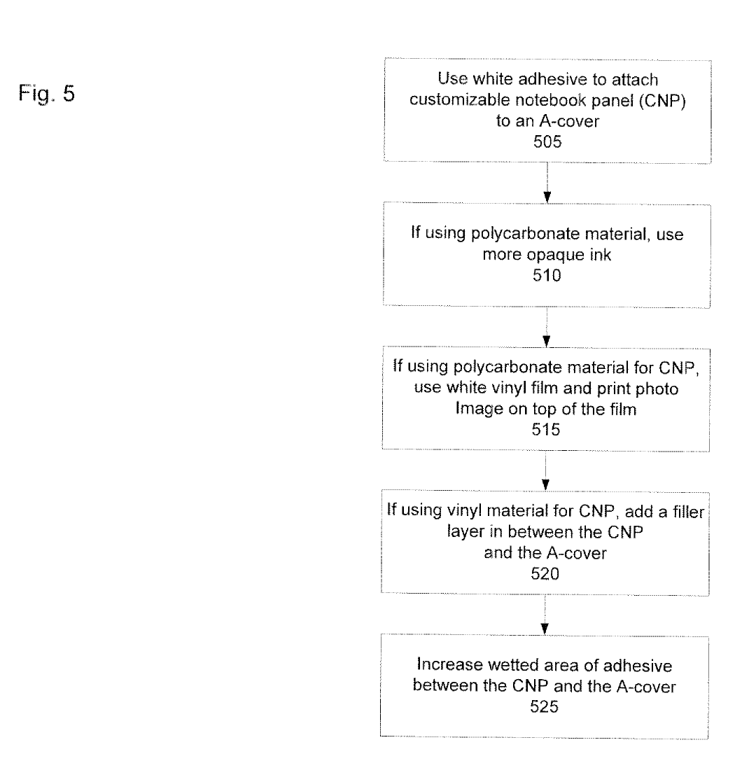

FIG. 5 is a block diagram that illustrates an example of a process that may be used to prevent problems that may be associated with using CNP in notebook computer systems, in accordance with some embodiments. Although the process may include multiple operations, it may be noted that some operations may be omitted if the situation does not apply. Furthermore, some operations may be performed in different orders as the order illustrated in FIG. 5. At block 505, a white adhesive may be used to attach a CNP to an A-cover. This is instead of a clear adhesive. At block 510, when the CNP is manufactured using polycarbonate material, a more opaque ink may be used to print a photo image onto the CNP. At block 515, when the polycarbonate material is used, a white vinyl film may be used and the photo image may be printed on top of the film. At block 520, when the CNP is manufactured using vinyl material, a filler layer may be used in between the CNP and the A-cover. The filler layer may be integrated into the CNP during the manufacturing of the CNP. At block 525, the wetted area of the adhesive between the CNP and the A-cover may be increased. This may help reducing the imperfections associated with the adhesive.

Although the present invention has been described with reference to specific exemplary embodiments, it will be evident that various modifications and changes may be made to these embodiments without departing from the broader spirit and scope of the invention as set forth in the claims. For example, the term notebook computer system may be used broadly as any portable computer systems that include surface areas where CNPs may be attached. Furthermore, the computer system described above may be non-portable computer systems which may include surface areas that may accommodate CNPs for customization. Accordingly, the specification and drawings are to be regarded in an illustrative rather than a restrictive sense.

What is claimed is:

1. A method, comprising:
attaching a customizable notebook panel (CNP) to a surface of a computer system to customize appearance of the computer system, wherein the CNP is manufactured with a photo image and is attached to the surface using a white color adhesive.

2. The method of claim 1, wherein an amount of white color adhesive is applied until visible streaks or bubbles caused by the white color adhesive on the surface is reduced.

3. The method of claim 1, wherein when the CNP is manufactured using a vinyl material, a solid color filler layer is used in between the CNP and the surface.

4. The method of claim 3, wherein the filler layer is integrated with the CNP.

5. The method of claim 1, wherein when the CNP is manufactured using a polycarbonate material, printing of the photo image on the polycarbonate material is performed using inks that are opaque.

6. The method of claim 5, wherein printing of the photo image on the polycarbonate material includes adding a solid color vinyl layer on back of the photo image.

7. A computer system, comprising:
a lid unit having a display screen;
a based unit coupled to the lid unit and having a keyboard;
one or more surface areas associated with the lid unit or with the base unit; and
one or more customizable surface panels (CNP) attached to the one or more surface areas, wherein the one or more CNP is manufactured using a photo image and is attached using a white adhesive color.

8. The system of claim 7, wherein an amount of white color adhesive is applied between the one or more CNP and the one or more surface areas until any visible streaks or bubbles caused by the white color adhesive on the one or more surface areas is reduced.

9. The system of claim 8, wherein when a first CNP is manufactured using a vinyl material, a solid color filler layer is used in between the first CNP and a first surface area that the first CNP is to be attached to.

10. The system of claim 9, wherein the filler layer is integrated with the first CNP.

11. The system of claim 7, wherein when a second CNP is manufactured using a polycarbonate material, the photo image is printed on the polycarbonate material using opaque inks.

12. The system of claim 11, wherein a solid color vinyl layer is applied on to back of the photo image.

13. A method, comprising:
applying a layer of white color adhesive onto a recessed area of a lid unit of a computer system, the lid unit including a display screen on a surface opposite from a surface having the recessed area; and
placing a customizable notebook panel (CNP) onto the layer of white adhesive after the white adhesive has been applied until any visible streaks or bubbles caused by the white color adhesive is reduced from showing through the CNP, wherein CNP is manufactured with a photo image.

14. The method of claim 13, further comprising:
increasing surface energy of the white color adhesive until it is less than or at most equal to surface energy of the recessed area.

15. The method of claim 14, wherein when the CNP is manufactured using a vinyl material, the CNP includes an integrated solid color filler layer.

16. The method of claim 14, wherein when the CNP is manufactured using a polycarbonate material, the photo image is printed on the polycarbonate material using opaque inks.
